(19) United States
(12) Patent Application Publication
(10) Pub. No.: US 2007/0087170 A1
(43) Pub. Date: Apr. 19, 2007

(54) Manufacturing method of tape and tape

(75) Inventors: Kyouhisa Uchiumi, Kanagawa (JP); Yutaka Kakuishi, Kanagawa (JP); Shinichi Sugawara, Kanagawa (JP); Hideaki Yamada, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION

(21) Appl. No.: 11/580,914

(22) Filed: Oct. 16, 2006

(30) Foreign Application Priority Data
Oct. 14, 2005 (JP) 2005-299874

(51) Int. Cl. B32B 23/02

(52) U.S. Cl. 428/192

(57) ABSTRACT

A manufacturing method of a tape for manufacturing a curved tape curving in the width direction along the longitudinal direction of the tape, wherein, in a cutting process which cuts an original tape with a wide width into a plurality of tapes with a predetermined width by continuously passing the original tape between a rotary blade and a rotary bed knife having a receiving portion for receiving the rotary blade, an edge which has a shorter edge length between both edges in the width direction of the tape is to become a cut side by being pushed into the receiving portion of the rotary bed knife.

### CROSS REFERENCE TO RELATED APPLICATIONS

This application claims the foreign priority benefit under Title 35, United States Code, §119(a)-(d) of Japanese Patent Application No. 2005-299874, filed on Oct. 14, 2005, the contents of which are hereby incorporated by reference.

### BACKGROUND OF THE INVENTION

1. Field of the Invention

The present invention relates to a manufacturing method of a tape and a tape, and, more particularly to a manufacturing method of a tape which is given a shape curving in the width direction of the tape along the longitudinal direction, and to the tape.

2. Description of the Related Art

Generally, as an external storage medium for data backup of a computer and the like, for example, a linear type or a helical type magnetic tape with a 12.7 mm width is widely used. The tape is handled with a wound status on a tape reel. However, when the tape is wound on the tape reel in a winder or a drive, a position of an end face of a tape edge is likely to be irregular (so called, irregular tape winding). Especially, in a high speed winding, a significant irregular tape winding may take place. The irregular tape winding may cause edge damage of the tape during transportation. In addition, by giving an irregular winding tendency to the tape during storage, tape drive accuracy in a drive decreases, thereby causes servo tracking errors. Because of the above reason, to secure a good winding appearance when a tape is shipped, thereby to manufacture a magnetic tape hardly to be irregular in a drive, is important to guarantee a required performance of the product.

It has been known that if a winding tendency to become a predetermined curved shape is given to a magnetic tape, a good winding appearance is secured and a tape drive becomes stable, thereby improves servo tracking performance. This is disclosed in, for example, claim 1 and paragraphs 0042-0045 of Japanese Patent Laid-Open Publication No. 2004-164808, and claim 1, paragraphs 0018, 0031, and FIG. 1 of Japanese Patent Laid-Open Publication No. 2004-280920. The predetermined curved shape is a shape which curves a predetermined quantity in the width direction of a magnetic tape along the longitudinal direction when the magnetic tape is placed on a flat surface and viewed with a plane view. If a magnetic tape constantly has such a predetermined curved shape in the longitudinal direction, a constant force is given to the edge with a shorter edge length (length of edge periphery in the width direction, hereinafter, referred to as shorter edge) between both edges in the width direction (both edge peripheries in the width direction), thereby resulting in a good winding appearance. On the other hand, if a constant curved shape is not given, the winding appearance becomes bad.

Meanwhile, as shown in FIG. 6, a magnetic tape 100 is manufactured by continuously passing a wide original magnetic tape through a slitter 103, which is composed of an upper blade 101 and a lower blade 102, thereby cutting the wide original magnetic tape into a plurality of tapes. Here, due to cutting of the magnetic tape 100 by being pushed to a side of the lower blade 102 by the upper blade 101 of the slitter 103, so-called, a drooping (a shape drooped in a pushed direction) is formed on a pushed edge 100a. This is disclosed in, for example, paragraphs 0004-0005 and FIG. 1 of Japanese Patent Laid-Open Publication No. H11-296839, and a paragraph 0004, FIG. 14, and FIG. 15 of Japanese Patent Laid-Open Publication No. 2001-273629. On the contrary, no or less drooping is formed on an edge 100b on the opposite side.

As shown in FIG. 7, in a magnetic tape 104 described in the Japanese Patent Laid-Open Publication No. 2004-164808 and No. 2004-280920, because a shorter edge 104a is always shifted to a same direction (edge 104a side), damages are generated on an end face of the edge 104a by a friction between the edge 104a and a carrying guide or a restriction guide (not shown). Therefore, due to accumulation of the damage on the end face of the edge 104a, a neighborhood 104c of the damaged edge 104a is swollen in a radial direction on a periphery side 104b of the magnetic tape 104, which is wound up on a hub 105a of a reel 105. As a result, tape drive performance is affected by the above, thereby resulting in causing tracking errors.

In addition, in the magnetic tape 100 in FIG. 6, shapes of both edges 100a and 100b, which are formed in the cutting, effect on the swelling (that is, the swelling in the damaged neighborhood 104c shown in FIG. 7) in the radial direction.

It is, therefore, an object of the present invention to provide a manufacturing method of a tape and a tape which decrease tracking errors in regard to a tape having a curved shape, as well as eliminating the aforementioned problems.

### SUMMARY OF THE INVENTION

Studying hard for solving the aforementioned problem, inventors of the instant application found that a generation probability of tracking errors is decreased by properly matching an orientation of a curved shape of a tape with a tape edge shape which is formed in the cutting when an original tape is cut.

According to a first aspect of the present invention, there is provided a manufacturing method of a tape for manufacturing a curved tape curving in the width direction of the tape along the longitudinal direction, wherein, in a cutting process which cuts an original tape with a wide width into a plurality of tapes with a predetermined width by continuously passing the original tape between a rotary blade and a rotary bed knife having a receiving portion for receiving the rotary blade, an edge side with a shorter edge length between both edges in the width direction of the tape is to become a cut side by being pushed into the receiving portion of the rotary bed knife.

In the first aspect of the present invention, the edge with a shorter edge length between the both edges in the width direction of the tape is cut by being pushed into the receiving portion. The inventors of the present invention found that as a result of the cutting, where the edge with a shorter edge length is cut by being pushed into the receiving portion, edge damage is decreased, and in addition, a swelling in the neighborhood of the outer winding periphery disappears even if the edge damage is accumulated. This is supposed that because a drooping is generated on the edge with a shorter edge length, a thickness of the tape as a whole does not change even if the tape edge is deformed by coming in contact with a carrying guide when the tape is driven.

According to a second aspect of the present invention, there is provided a manufacturing method of a tape, wherein the method has a determination process ahead of the cutting process for determining an orientation of a curved shape to be given after cutting of the tape, and an orientation of the rotary blade and an orientation of the rotary bed knife can be exchanged in accordance with the orientation of the curved shape determined in the determination process.

In the second aspect, orientations of the rotary blade and rotary bed knife can be exchanged in accordance with an orientation of the curved shape to be given after cutting of the tape so that the edge with a shorter edge length is to become the edge side to be pushed into the receiving portion of the rotary bed knife.

According to a third aspect of the present invention, there is provided a manufacturing method of a tape, wherein an orientation of the rotary blade and an orientation of the rotary bed knife can be exchanged in accordance with a curved shape that an original tape has in advance.

In the third aspect, orientations of the rotary blade and rotary bed knife can be exchanged in accordance with a curved shape that an original tape has in advance so that the edge with a shorter edge length is to become the edge to be pushed into the receiving portion of the rotary bed knife.

According to a fourth aspect of the present invention, there is provided a manufacturing method of a tape, wherein the tape is a magnetic tape.

In the fourth aspect, as a result of the cutting where the edge with a shorter edge length is cut by being pushed into the receiving portion, edge damage is decreased, and in addition, a magnetic tape which has a less swelling in the neighborhood of the outer winding periphery can be obtained even if the edge damage is accumulated.

According to a fifth aspect of the present invention, there is provided a tape which is manufactured by the manufacturing method of a tape of the present invention, wherein a drooping is formed on the edge of the shorter edge length along the longitudinal direction of the tape.

In the fifth aspect, a drooping is formed on the edge of the shorter edge length along the longitudinal direction of the tape. Through this, damage on the edge with a shorter edge length is decreased when the tape is driven. In addition, a swelling in the neighborhood of edge of the outer winding periphery becomes hard even if the damage is accumulated.

In the manufacturing method of a tape and a tape according the present invention, since a swelling in the neighborhood of edge of the outer winding periphery does not happen, a generation probability of tracking errors can be decreased.

### BRIEF DESCRIPTION OF THE DRAWINGS

FIG. 1 is a plane view showing a magnetic tape according to an embodiment of the present invention;

FIG. 2A is a cross sectional view showing the magnetic tape cut at a II-II line in FIG. 1;

FIG. 2B is a cross sectional view showing the magnetic tape in FIG. 1 after driving;

FIG. 3 is a side view of a cutting apparatus for explaining a manufacturing method of a magnetic tape according to the embodiment;

FIG. 4A is a front view showing a configuration of a cutting unit of a cutting apparatus;

FIG. 4B is an enlarged illustration of a main part of FIG. 4A;

FIG. 5 is a cross sectional view of a magnetic tape wound on a reel hub of a winding reel;

FIG. 6 is an illustration showing a configuration of a cutting unit of a conventional cutting apparatus; and

FIG. 7 is a plane view showing a status where a magnetic tape is wound on a reel with a flange.

### DETAILED DESCRIPTION OF THE PREFERRED EMBODIMENT

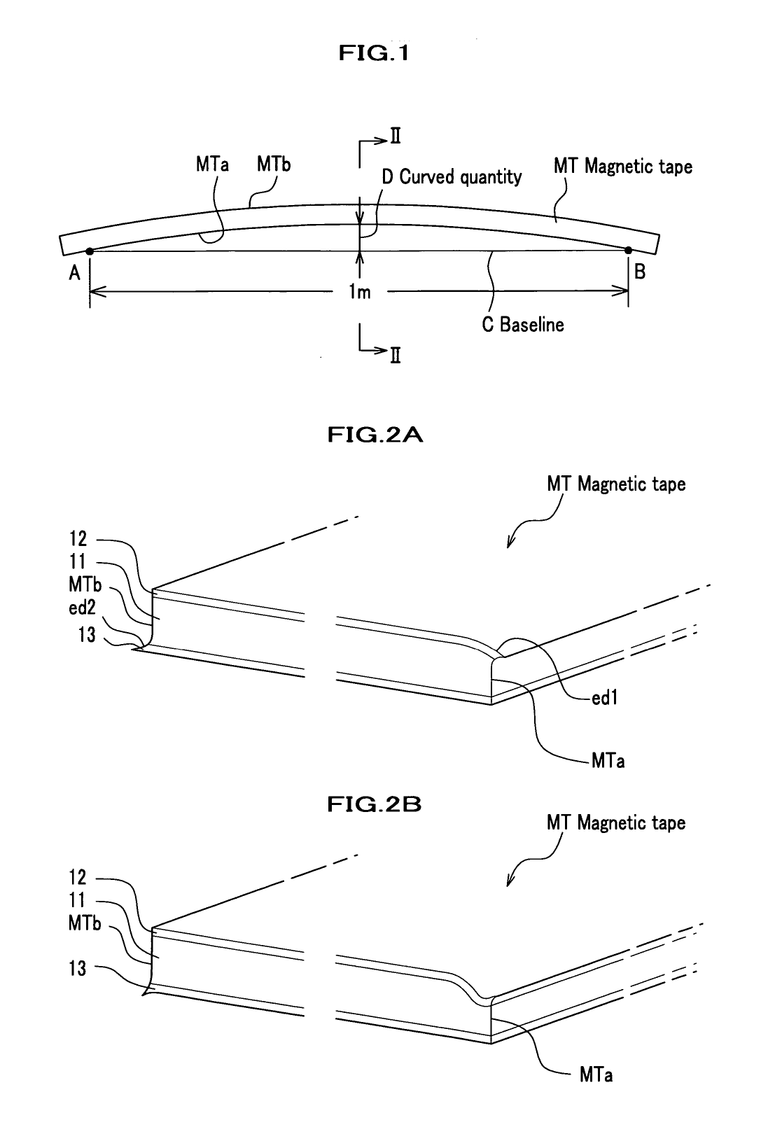

Next, an embodiment of a manufacturing method of a tape according to the present invention will be explained in detail by referring to figures, as needed. FIG. 1 is a plane view showing a magnetic tape according to an embodiment of the present invention. FIG. 2A is a cross sectional view of the magnetic tape cut at II-II line in FIG. 1. FIG. 2B is a cross sectional view showing the magnetic tape in FIG. 2A after driving the magnetic tape.

It should be noted that, in the embodiment, a magnetic tape is supposed as a tape to be manufactured, but the present invention is not limited thereto. All tapes that can be given a curved shape other than various kinds of tape storage media, such as an optical storage medium, can also be applied.

As shown in FIG. 1, a magnetic tape MT to be manufactured according to the embodiment is formed in a shape so as to curve in the width direction from a baseline C which connects both longitudinal end points A and B when the magnetic tape is placed on a flat surface. Both edges MTa, MTb of the magnetic tape MT have a different edge length each other. In the embodiment, an edge with a shorter edge length (hereinafter, referred to as shorter edge) is assigned to an edge MTa (inner edge of the curved edge) and an edge with a longer edge length (hereinafter, referred to as longer edge) is assigned to an edge MTb (outer edge of the curved edge). Meanwhile, it is preferable that a range of a curved quantity D, which is a maximum distance from the baseline C to the edge MTa, per 1 m is between no less than 0.5 mm/m and no more than 8.0 mm/m. In FIG. 1, an orientation of the curved shape of the magnetic tape MT is made upward. However, the orientation may be the opposite direction (downward) in accordance with a final product of the tape.

As shown in FIG. 2A, the magnetic tape MT includes a nonmagnetic support 11, a magnetic layer 12 formed on a surface of the support 11, and a back coat layer 13 formed on the backside. Both edges MTa, MTb of the magnetic tape have a different slit end face shape to each other. Specifically, on the shorter edge MTa, an irregular edge part ed1 is formed on an upper side, that is, so-called a drooping (convex in the backside direction) is generated. On the other hand, on the longer edge MTb, an irregular edge part ed2 is formed on a bottom side. Meanwhile, when the magnetic tape MT is driven, the edges MTa, MTb are deformed due to a friction with a guide. As a result, as shown in FIG. 2B, the edge part ed1 (refer to FIG. 2A) on the shorter edge MTa side is collapsed. In addition, on the longer edge MTb side, the edge part ed2 (refer to FIG. 2A) is deformed, as a result, a tape thickness becomes thicker than that of before the driving.

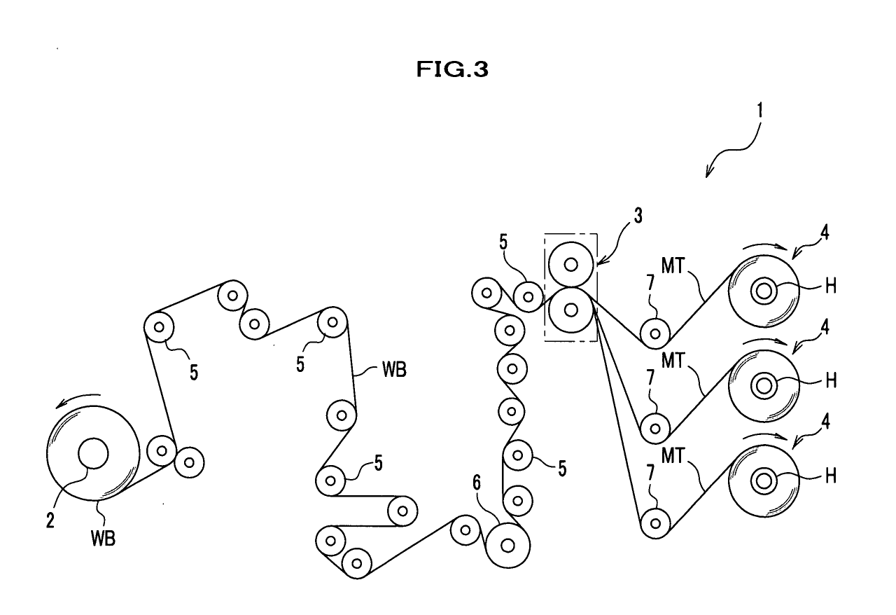

Next, a manufacturing method of a magnetic tape according to the embodiment will be explained. FIG. 3 is a side view of a cutting apparatus for explaining a manufacturing method of a magnetic tape according to the embodiment.

As shown in FIG. 3, a cutting apparatus 1 for manufacturing a magnetic tape includes, as major members, a feeding reel 2 on which a web WB is set, a cutting unit 3 for manufacturing a plurality of magnetic tapes MT by cutting the web WB into a predetermined width, and a winding reel 4 for winding the magnetic tape MT on a reel hub H, and other than the above, also includes a guide roller 5 guiding the web WB from the feeding reel 2 to the cutting unit 3, a single grand suction drum 6, and a tension roller 7 disposed in accordance with the winding reel 4.

On the feeding reel 2, a web WB, which is an original magnetic tape wound in a roll, is set. The original magnetic tape is configured such that a magnetic layer is formed on a surface of a nonmagnetic support and a back coat layer is formed on the backside of the support.

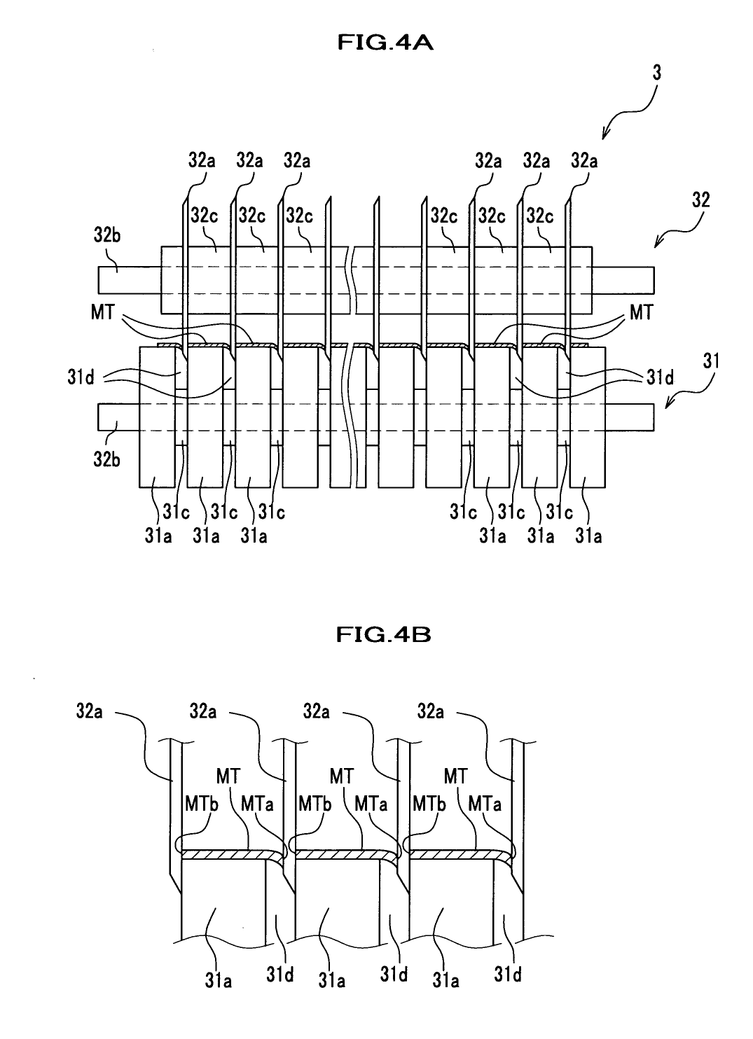

FIG. 4A is a front view showing a configuration of a cutting unit of a cutting apparatus. FIG. 4B is an enlarged illustration of a main part of the FIG. 4A. As shown in FIG. 4A, the cutting unit 3 has a lower blade 31 and an upper blade 32.

The lower blade 31 is configured such that a plurality of cylindrical lower rotary blades 31a (rotary bed knives) are engaged with and fixed on a lower shaft 31b through a spacer 31c. A space between the lower rotary blades 31a forms a receiving portion 31d, which will be described later, of an upper rotary blade 32a. The lower shaft 31b is connected to a rotary motor (not shown) and capable of rotation in accordance with a carrying speed of the magnetic tape MT.

The upper blade 32 is configured such that a plurality of thin disk upper rotary blades 32a (rotary blades) are engaged with and fixed on an upper shaft 32b through a spacer 32c. The upper rotary blade 32a is being forced to a right side in an axial direction in FIG. 4A, and a positioning of a blade edge of the upper rotary blade 32a is made by coming in contact with a side face of the lower rotary blade 31a. The upper shaft 32b is arranged in parallel with the lower shaft 31b, and rotates in the opposite direction of that of the lower shaft 31b in synchronization with the rotation of the lower shaft 31b. It should be noted that positions of the lower blade 31 and the upper blade 32 can be exchanged each other in accordance with an orientation of a curved shape that is given to the original magnetic tape (magnetic tape MT). The orientation will be explained in explanation of an operation of the cutting unit 3.

As shown in FIG. 3, the winding reel 4 is a reel for winding a magnetic tape MT, which is cut into a predetermined width by the cutting unit 3, on the reel hub H. The feeding reel 2 and the winding reel 4 are rotatably driven by driving motors (not shown).

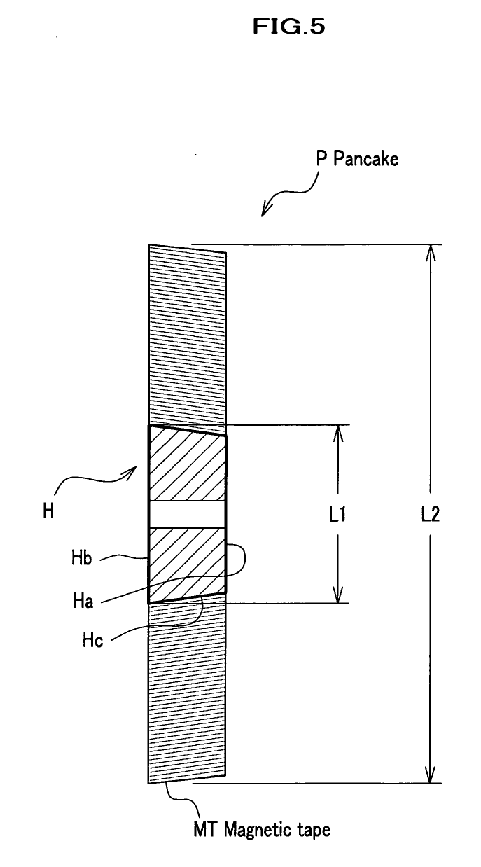

FIG. 5 is a cross sectional view showing a magnetic tape MT wound on a reel hub of a winding reel.

As shown in FIG. 5, the reel hub H is used for giving a curved shape to the magnetic tape MT, and has a tapered shape where a winding surface Hc is formed in a taper between edges Ha and Hb, which are at each end face, in the axial direction of the reel hub H. A side of the edge Ha which has a smaller diameter is a side where the shorter edge MTa of the magnetic tape MT is positioned. A diameter L1 of the reel hub H is no less than 115 mm, and a ratio (L1/L2) of a hub diameter L1 to that of a pancake P L2, which is a state where the magnetic tape is wound on the hub, is 0.3 to 0.99.

In addition, a tapered quantity of the reel hub H against a curved quantity D to be given is shown in a table 1.

TABLE 1

| | Curved quantity (mm/m) | | | | |
|---|---|---|---|---|---|
| | 0.5 | 1 | 2 | 4 | 8 |
| Ratio of top to | 1.00007 | 1.0001 | 1.0003 | 1.0006 | 1.0012 |
| bottom edge radius | | | | | |

Next, a manufacturing method of a magnetic tape MT using the cutting apparatus 1 will be further explained in detail with respect to an operation of the cutting unit after explanation of the total flow, by referring to FIG. 3, FIG. 4A, and FIG. 4B.

First, an orientation of a curved shape to be given to the magnetic tape MT is determined. Then, the lower blade 31 and the upper blade 32 are exchanged in accordance with the orientation. In the embodiment, depending on an orientation of the reel hub H of the winding reel 4, the shorter edge MTa of the magnetic tape MT is made to correspond, specifically, to the edge Ha side of the reel hub H. Then, the lower blade 31 and the upper blade 32 are set by exchanging their orientations so that the shorter edge MTa of the magnetic tape becomes a side to be pushed into the receiving portion 31d of the lower blade 31.

Next, as shown in FIG. 3, the web WB is fed from the feeding reel 2 on which the web WB is wound, and cut into a plurality of magnetic tapes with a predetermined width by continuously passing the web WB through the cutting unit 3. The cut magnetic tape MT is wound on the reel hub of the winding reel 4, while a tension of the cut magnetic tape is adjusted by a tension roller 7.

Subsequently, the pancake P (refer to FIG. 5) is removed from the winding reel 4, and subjected to a heat treatment for a predetermined time at a predetermined temperature. As a result, the magnetic tape MT is given a predetermined curved shape. In the above process, the pancake P is heat-treated according to the following formula.
t≧kT⁻⁵ (1)
where, t is a time (hour), k is a coefficient, and T is a heat treatment temperature (° C.).

Here, the coefficient k is a proportional constant to be determined by a support of the magnetic tape MT (original magnetic tape). For example, when a polyethylene terephthalate (PET) is used for the support of the magnetic tape MT (original magnetic tape), a sufficient effect for giving a curved shape is obtained for practical use by selecting k=10¹⁰, more preferably k=2×10¹⁰. In addition, the heat treatment temperature is no more than a glass transition temperature of the magnetic tape MT.

Further, an operation of the cutting unit 3 will be explained.

As shown in FIG. 4B, when an original magnetic tape of the web WB (refer to FIG. 3) is fed to the cutting unit 3, the original magnetic tape is pushed into a receiving portion 31d side of the lower rotary blade 31a by the upper rotary blade 32a, while the original magnetic tape is wound by the lower rotary blade 31a, thereby resulting in generation of a shear stress. Through this process, the original magnetic tape is cut into a plurality of magnetic tapes, and accordingly, a magnetic tape with a predetermined width is manufactured.

At this time, as described above, the lower blade 31 and upper blade 32 are set facing to each other in advance so that the shorter edge MTa of both edges in a width direction of a magnetic tape MT to be cut becomes a side to be pushed into the receiving portion 31d of the lower blade 31. By cutting an original magnetic tape with the cutting unit 3 configured as described above, the drooping is formed on the shorter edge MTa side (refer to FIG. 2).

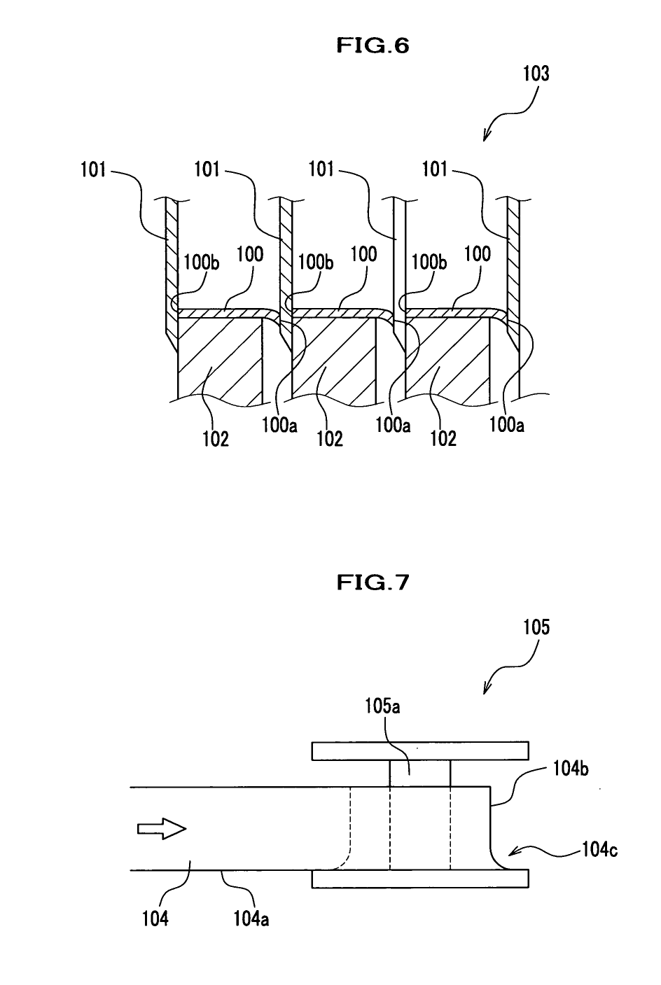

When the magnetic tape MT manufactured with the above process is wound on a reel (not shown), it was found that a generation probability of edge damage was drastically decreased and a swelling in a radial direction as shown in FIG. 6 disappeared, compared with a case where the longer edge MTb became a side to be pushed into the receiving portion 31d. Specifically, a damage generation was examined by measuring whether or not the swelling was formed, or measuring a quantity of the swelling. As a result, it was found that when the longer edge MTb was the side to be pushed into the receiving portion 31d, a damage generation rate was 25%, and, on the other hand, that of the magnetic tape MT manufactured according to the embodiment was 3%.

According to the above description, the following advantages can be obtained in the embodiment.

Since the magnetic tape MT manufactured according to the embodiment has a curved shape in the width direction along the longitudinal direction, a high speed winding of the tape becomes available, as well as a quality of a winding appearance can be improved.

In addition, a generation of edge damage of the shorter edge MTa is decreased in the magnetic tape MT manufactured according to the embodiment, and also a swelling in the radial direction can be suppressed even if the edge damage is accumulated when the film is wound on the reel. Accordingly, a generation probability of tracking errors can be decreased.

The embodiment has been explained. However, the present invention is not limited to the above embodiment, and various modifications can be embodied.

In the aforementioned embodiment, the lower blade 31 and the upper blade 32 are set in accordance with a curved shape, which is given in a later process, of the magnetic tape MT. However, the present invention is not limited thereto. For example, orientations of the lower blade 31 and upper blade 32 can be exchanged in accordance with a curved shape that an original magnetic tape has in advance. Specifically, a curved shape which is formed in proportion to a thickness difference in the width direction of the original magnetic tape is used. A direction that a magnetic tape curves in when the web WB passes through the slit is determined by measuring an outline of the web WB which is set on the feeding reel 2 with a laser displacement gauge and the like. Accordingly, the lower blade 31 and the upper blade 32 can be configured so that their orientations are exchanged in accordance with the curved shape.

In addition, the lower blade 31 and the upper blade 32 can be configured so that orientations of the lower blade 31 and upper blade 32 and a direction of the curved shape to be given are matched, by inserting a rewinding process before giving the curved shape.

Further, an orientation of the lower blade 31 and that of the upper blade 32 may be exchanged in accordance with a process number (for example, rewinding process) from a slit process to a servo-writing inspection process. For example, if orientations of the lower blade 31 and upper blade 32 in a case where four processes, a curved shape giving process → a servo-writing process → an integration process → an inspection process, are processed in this order after the slit process is assumed as a normal blade set (present embodiment case), a case where the rewinding process is inserted in these processes (that is, five processes, a rewinding process → a curved shape giving process → a servo-writing process → an integration process → an inspection process, are processed) becomes a reverse blade set where orientations of the lower blade 31 and upper blade 32 are opposite to that of the normal blade set for the magnetic tape MT which has same direction of the curved shape to be given.

Furthermore, when a curved shape is not given in a later process, that is, when a curvature of an original magnetic tape is used, if a case where three processes, a servo-writing process → an integration process → an inspection process, are processed is assumed as a reverse blade set, a case where a winding process is inserted in the processes (that is, four processes, a rewinding process → a servo-writing process → an integration process → an inspection process, are processed) becomes a normal blade set for the magnetic tape MT having same direction of the curved shape to be given.

What is claimed is:

1. A manufacturing method of a tape curved in a width direction along a longitudinal direction, comprising a cutting process for cutting a wide original tape into a plurality of tapes with a predetermined width by continuously passing the wide original tape between a rotary blade and a rotary bed knife having a receiving portion for receiving the rotary blade,
wherein an edge which has a shorter edge length between both edges in the width direction of the tape is a cut side to be pushed into the receiving portion of the rotary bed knife.

2. The manufacturing method of a tape according to claim 1, further comprising a determination process prior to the cutting process for determining an orientation of a curved shape to be given after cutting of the tape,
wherein an orientation of the rotary blade and an orientation of the rotary bed knife can be exchanged in accordance with the orientation of the curved shape determined in the determination process.

3. The manufacturing method of a tape according to claim 1,
wherein an orientation of the rotary blade and an orientation of the rotary bed knife are exchanged in accordance with a curved shape that the original tape has in advance.

4. The manufacturing method of a tape according to claim 1, further comprising a rewinding process for rewinding the tape so that orientations of the rotary blade and rotary bed knife are matched with a direction of a curved shape to be given after the cutting process.

5. The manufacturing method of a tape according to claim 1, further comprising an input process for inputting a process number of the rewinding after the cutting process, and an orientation of the rotary blade and an orientation of the rotary bed knife are exchanged in accordance with the process number of the rewinding.

6. The manufacturing method of a tape according to claim 1,
wherein the tape is a magnetic tape.

7. A tape manufactured according to claim 1,
wherein a drooping is formed on the edge of the shorter edge length along the longitudinal direction of the tape.

8. A manufacturing apparatus of a tape curved in a width direction along a longitudinal direction, comprising:
a feeding reel on which a wide original tape is wound as a roll;
a cutting unit, which has a rotary blade and a rotary bed knife having a receiving portion of the rotary blade, for cutting the original tape into a plurality of tapes with a predetermined width by continuously passing the original tape between the rotary blade and the rotary bed knife;
a plurality of winding reels, each of which has a reel hub, for winding the plurality of tapes on each reel hub;
means for determining an orientation of a curved shape of a tape to be manufactured; and
means for exchanging orientations of the rotary blade and rotary bed knife in accordance with the orientation determined by the means for determining an orientation.

9. The manufacturing apparatus according to claim 8,
wherein the means for determining an orientation includes means for measuring an outline of the original tape which is set on the feeding reel.

10. The manufacturing apparatus according to claim 8,
wherein the reel hub has a winding surface with a tapered shape, and the winding surface has edges of a smaller diameter and a larger diameter;
the means for determining an orientation determines an orientation of the curved shape of the tape to be manufactured by an orientation of the reel hub, wherein the edge of the smaller diameter of the winding surface is an edge with a shorter edge length between both edges in the width direction of the tape; and
the means for exchanging orientations exchanges orientations of the rotary blade and rotary bed knife so that the edge with a shorter edge length between both edges in the width direction of the tape is a cut side to be pushed into the receiving portion of the rotary bed knife.
